(19) United States
(12) Patent Application Publication
(10) Pub. No.: US 2024/0346193 A1
(43) Pub. Date: Oct. 17, 2024

(54) METHOD AND SYSTEM FOR MULTI-PARTICIPANT-BASED CONCEPTUAL DESIGN INFORMATION MODELING

(71) Applicant: Sichuan University, Chengdu (CN)

(72) Inventors: Wenqiang LI, Chengdu (CN); Jiawei WANG, Chengdu (CN); Yucheng YAN, Chengdu (CN); Wenhui ZHU, Chengdu (CN); Hao ZHANG, Chengdu (CN); Pan ZOU, Chengdu (CN); Diwang TENG, Chengdu (CN)

(21) Appl. No.: 18/751,183

(22) Filed: Jun. 21, 2024

(30) Foreign Application Priority Data
Jul. 25, 2023 (CN) 202310919576.7

(51) Int. Cl. G06F 30/12; G06F 111/02

(52) U.S. Cl. CPC G06F 30/12; G06F 2111/02

(57) ABSTRACT

A method and system for multi-participant based conceptual design information modeling. The method includes the following steps. Initial design information generated by a plurality of design participants involved in different design stages during conceptual design of a target product is acquired. The initial design information is screened to obtain target design information in a target carrier form according to a carrier form corresponding to the initial design information. Subject information is extracted from the target design information. Based on a plurality of visualized forms under a plurality of dimensions, a plurality of visualized views of the subject information are generated under the plurality of dimension. A visualized view corresponding to a display authority of a design participant is displayed on the graphical user interface. The design participant can modify the design information based on the visualized view to obtain a target design information model.

### CROSS-REFERENCE TO RELATED APPLICATIONS

This application claims the benefit of priority from Chinese Patent Application No. 202310919576.7, filed on Jul. 25, 2023. The content of the aforementioned application, including any intervening amendments thereto, is incorporated herein by reference in its entirety.

### TECHNICAL FIELD

This application relates to product conceptual design modeling, and more specifically to a method and system for multi-participant-based conceptual design information modeling.

### BACKGROUND

Product conceptual design refers to a series of orderly, organizable and targeted design activities from analysis of user requirements to generation of conceptual products, which is an evolving process from fuzzy to clear, from rough to modified, and from abstract to concrete. Product model refers to a data structure relating to product data organized in a certain form, and is also known as a logical model of product data. Product conceptual design information model plays an important role in the design and generation of product conceptual schemes. The ultimate purpose of the product conceptual design information model is to help design participants to conceptualize and get product conceptual schemes.

Product conceptual design is the initial stage of the product development process, where ideas and concepts are generated and explored to define the overall form, function and characteristics of the product. However, with the progress of conceptual design, a large amount of design information will be generated. Nevertheless, the design information concerned by different design participants is different, and the information that can be provided by those design participants to the conceptual design information model is also different. Hence, the design information is required to be effectively managed and organized to be displayed in different visual forms. On one hand, it helps the design participant to observe the design information for better design; on the other hand, it helps different design participants to interact with each other, thereby modifying the design information in the model.

### SUMMARY

An objective of the present disclosure is to provide a method and system for multi-participant based conceptual design information modeling to overcome the deficiencies in the prior art.

Technical solutions of the present disclosure are described below.

In a first aspect, this application provides a method for multi-participant based conceptual design information modeling, providing a graphical user interface via a terminal device, the method comprising:
acquiring initial design information generated by a plurality of design participants respectively involved in different design stages during conceptual design of a target product, wherein the initial design information is configured to construct an initial design information model;
according to a carrier form corresponding to the initial design information, screening target design information in a target carrier form from the initial design information; and extracting subject information from the target design information;
based on a plurality of visualized forms under a plurality of dimensions, generating a plurality of visualized views of the subject information under the plurality of dimensions;
in response to a first display operation, displaying, on a graphical user interface, the plurality of visualized views respectively to the plurality of design participants based on display authority, wherein the graphical user interface is provided by a terminal device;
if the plurality of design participants have a modification authority, generating supplementary information to modify the plurality of visualized views in response to an information modification operation, wherein the supplementary information is configured to modify the initial design information model to obtain a target design information model; and
updating the plurality of visualized views according to the supplementary information to obtain a plurality of updated visualized view;

In some embodiments, the method further comprises:
in response to a second display operation, displaying, on the graphical user interface, the plurality of updated visualized views to the plurality of design participants based on the display authority.

In some embodiments, the initial design information is acquired through the following steps:
acquiring input information of each of the plurality of design participants in response to an information input operation, wherein the input information comprises research and development information, and research and development attribute information generated during a research and development process; and selecting information in the input information corresponding to an input authority of the plurality of design participants as the initial design information.

In some embodiments, the carrier form comprises textual form; and the step of obtaining target design information in a target carrier form from the initial design information by screening and extracting subject information from the target design information comprises:
screening the target design information in the text form from the initial design information; and
subjecting the target design information to text processing to obtain a subject word of the target design information.

In some embodiments, the step of based on a plurality of visualized forms under a plurality of dimensions, generating a plurality of visualized views of the subject information under the plurality of dimension comprises:
dividing the subject information into a plurality of levels based on a vertical product dimension; and generating a plurality of first visualized views respectively corresponding to the plurality of levels; and
generating a plurality of second visualized views corresponding to the subject information in accordance with a preset mapping relationship based on a horizontal part dimension, wherein the plurality of visualized views comprises the plurality of first visualized views and the plurality of second visualized views.

In some embodiments, when displaying the plurality of visualized views, displaying an operation authority identification of the design participant on the visualized view.

In some embodiments, the display authority is determined through the following steps:
constructing a mapping relationship between the plurality of design participants and the plurality of visualized views based on a concerning design content of the plurality of design participants and an actual situation of the conceptual design of the target product; and
correspondingly configuring the display authority for the plurality of design participants based on the mapping relationship.

In a second aspect, this application provides a system for multi-participant based conceptual design information modeling, comprising:
an acquisition module;
a screening module;
a generation module; and
a displaying module;
wherein the acquisition module is configured to acquire initial design information generated by a plurality of design participants respectively involved in different design stages during a conceptual design process of a target product, wherein the initial design information is configured to construct an initial design information model;
the screening module is configured to screen target design information in a target carrier form from the initial design information according to a carrier form corresponding to the initial design information, and extract subject information from the target design information;
the generation module is configured to generate a plurality of visualized views of the subject information under a plurality of dimension, based on a plurality of visualized forms under the plurality of dimensions; and
the displaying module is configured to display the plurality of visualized views respectively to the plurality of design participants based on display authority on the graphical user interface in response to a first display operation, wherein the graphical user interface is provided by a terminal device;
the generation module is also configured to generate a supplementary information to modify the plurality of visualized views in response to an information modification operation in a case that the plurality of design participants have a modification authority, and update the plurality of visualized views according to the supplementary information to obtain a plurality of updated visualized views, wherein the supplementary information is configured to modify the initial design information model to obtain a target design information model.

In a third aspect, this application provides an electronic device, comprising:
a processor;
a memory; and
a bus;
wherein the memory is configured to store machine-readable instructions executable by the processor; the processor is configured to be communicated with the memory via the bus when the electronic device is in operation; and the machine-readable instructions are configured to be executed by the processor to implement steps of the aforementioned method.

In a fourth aspect, this application provides a computer-readable storage medium, wherein the computer-readable storage medium is configured to store a computer program; and the computer program is configured to implement the aforementioned method when run by a processor.

The beneficial effects of the present disclosure are described as follows.

The method of the present application includes: acquiring initial design information generated by a plurality of design participants respectively involved in different design stages during conceptual design of a target product, wherein the initial design information is configured to construct an initial design information model; according to a carrier form corresponding to the initial design information, screening target design information in a target carrier form from the initial design information; and extracting subject information from the target design information; based on a plurality of visualized forms under a plurality of dimensions, generating a plurality of visualized views of the subject information under the plurality of dimension; in response to a first display operation, displaying, on a graphical user interface, the plurality of visualized views respectively to the plurality of design participants based on display authority, wherein the graphical user interface is provided by a terminal device; if the plurality of design participants have a modification authority, generating supplementary information to modify the plurality of visualized views in response to an information modification operation, wherein the supplementary information is configured to modify the initial design information model to obtain a target design information model.

In the present application, the initial design information is filtered and extracted to obtain subject information, which is transformed into visualized views under multiple dimensions. The visualized view is displayed under the corresponding authority to the design participant with different authorities, and the design participant can improve the information on the visualized view, which facilitates the reading of the information by the design participant, and effectively improves the efficiency of the information management.

To make the above purposes, features and advantages of the present application more obvious and understandable, preferable embodiments are listed as follows, which are described in detail below, with reference to the accompanying drawings.

### BRIEF DESCRIPTION OF THE DRAWINGS

To more clearly illustrate the technical solutions of the embodiments of the present application, the accompanying drawings used in the embodiments will be briefly introduced below. It should be understood that the following accompanying drawings merely show certain embodiments of the present application, and therefore should not be regarded to limit the scope of the present disclosure. Other related drawings can be obtained by one of ordinary skill in the art based on the accompanying drawings without making any creative labor.

FIG. 1 is a flow chart of a method for multi-participant based conceptual design information modeling according to an embodiment of the present disclosure;

FIG. 2 schematically illustrates a text processing model according to an embodiment of the present disclosure;

FIG. 3 schematically illustrates a visualized view according to an embodiment of the present disclosure;

FIG. 4 schematically illustrates another visualized view according to an embodiment of the present disclosure;

FIG. 5 schematically illustrates a displaying of a visualized view according to an embodiment of the present disclosure;

FIG. 6 is a schematic diagram of a system for multi-participant based conceptual design information modeling according to an embodiment of the present disclosure; and

FIG. 7 is a schematic diagram of an electronic device according to an embodiment of the present disclosure.

### DETAILED DESCRIPTION OF EMBODIMENTS

To make the purpose, technical solutions and advantages of the embodiments of the present application clearer, the technical solutions in the embodiments of the present application will be described clearly and completely below, with reference to the accompanying drawings in the embodiments of the present application. It should be understood that the accompanying drawings in the present application are merely intended for illustration and description, and are not intended to limit the scope of protection of the present application. Furthermore, it should be understood that the schematic accompanying drawings are not drawn to physical scale. The flowcharts used in this application illustrate operations realized in accordance with some embodiments of this application. It should be understood that the operations of the flowcharts may be implemented out of order, and steps that have no logical contextual relationship may be implemented in reverse order or simultaneously. In addition, one ordinary of skill in the art, guided by the contents of the present application, may add or remove one or more other operations to the flowchart.

Furthermore, the described embodiments are only a part of the embodiments of the present application. The components of embodiments of the present application generally described and illustrated in the accompanying drawings herein may be arranged and designed in a variety of different configurations. Accordingly, the following detailed description of embodiments of the present application provided in the accompanying drawings is not intended to limit the protection scope of the present application, but rather represents selected embodiments of the present application. Based on the embodiments of the present application, all other embodiments obtained by one of ordinary skill in the art without making creative labor shall fall within the scope of protection of the present application.

It should be noted that the term “including” used herein is intended to indicate the existence of the features declared thereafter, but does not exclude the addition of other features.

Product conceptual design refers to a series of orderly, organizable and targeted design activities from analyzing user requirements to generating conceptual products, which is an evolving changing process from fuzzy to clear, from rough to modified, from abstract to concrete. The ultimate goal of product conceptual design is to develop new products.

Product conceptual design is the initial stage of the product development process, where ideas and concepts are generated and explored to define the overall form, function and characteristics of the product. Conceptual design sets the foundation for information management throughout the product development process. It helps to explore ideas, validate concepts, understand user needs, and ultimately create products that are popular, viable, and successful in the marketplace. Conceptual design stakeholders (stakeholder) are all the people and things related to the conceptual design process. There are many stakeholders related to product conceptual design, including product pre-communication personnel, marketing personnel, product planning personnel, appearance styling design participants, industrial design participants, structural design participants, process design participants, quality management personnel, and product, which are all design participants. However, with the progress of the conceptual design, a large amount of design information will be generated. Nevertheless, the design information concerned by different design participants is different, and the information that can be provided to the conceptual design information model is also different. Hence, the design information is required to be effectively managed and organized to be displayed in different visual forms. It helps the design participant to observe the design information for better design.

Based on this, embodiments of the present application provide a method and a system for multi-participant based conceptual design information modeling, which are described below with reference to embodiments.

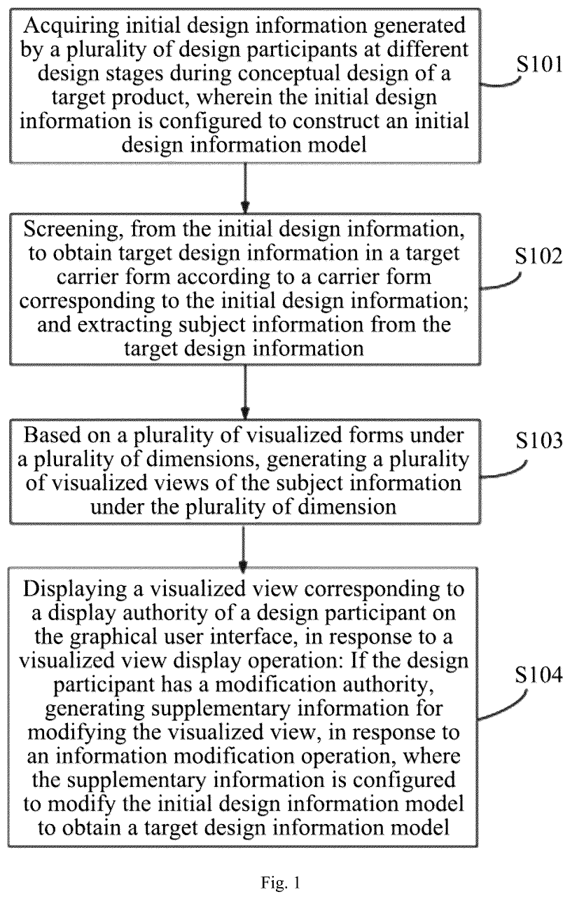

FIG. 1 is a flow chart of a method for multi-participant based conceptual design information modeling. The method includes the following steps.

(S101) Initial design information generated by a plurality of design participants respectively involved in different design stages during conceptual design of a target product is acquired, where the initial design information is configured to construct an initial design information model.

(S102) Target design information in a target carrier form is screened from the initial design information according to a carrier form corresponding to the initial design information, and subject information is extracted from the target design information.

(S103) Based on a plurality of visualized forms under a plurality of dimensions, a plurality of visualized views of the subject information are generated under the plurality of dimension;

(S104) The plurality of visualized views are displayed on the graphical user interface based on display authority, in response to a first display operation.

If the plurality of design participants have a modification authority, supplementary information is generated to modify the plurality of visualized views in response to an information modification operation, where the supplementary information is configured to modify the initial design information model to obtain a target design information model.

The plurality of visualized views are updated according to the supplementary information to obtain a plurality of updated visualized views.

In the embodiment of the present application, the subject information is obtained by screening and extracting from the initial design information, and is transformed into visualized views of multiple dimensions. The visualized view is displayed under the corresponding authority to the design participant with different authorities, and the design participant can improve the information on the visualized view, which facilitates the reading of the information by the design participant, and effectively improves the efficiency of the information management.

Some embodiments of the present application are described in detail below. The following embodiments and features in the embodiments may be combined with each other without conflict.

Embodiments of the present application provide a multi-participant-based information management method for conceptual design, which is mainly directed to information generated during a conceptual design process of a target product. The target product herein is characterized as a product to be designed in the embodiments of the present application.

Product conceptual design is complex and involves many design aspects, such as social demand survey and analysis, product design positioning, product function definition, conceptual product model prototype, and production structure design. Especially in the creative stage of design, it not only requires multi-level, multi-dimensional repeated thinking about the problem, but also creatively solves problems using abstract divergent thinking from the characteristics of the design object, creating the foundation for the product concept design. In this process, there are several design participants involved, such as product managers, users, concept design participants, and structural design participants. The users put forward user demands, which are the basis for product conceptual design. User demands are divided into explicit demands and potential demands. The explicit demand can be directly known by analyzing the market research data, and then guide the product conceptual design. The potential demand requires the fully exploration of the demand information by product conceptual design team, prediction of user's expectations, and minimization of the risk of investment in new product development using scientific methods. Concept design participants analyze user demands and transform them into corresponding functions or concepts. Structural design participants develop the corresponding product structure. The product manager is responsible for the overall design process of the target product.

During the conceptual design process of the target product by the design participants mentioned above, each design participant generates corresponding design information at each participation stage. This design information includes research and development (R&D) information and R&D attribute information. The R&D information is the information generated during the R&D process, such as name, function, requirements, behavior, structure, technical features, functional relationships, estimated time cost, estimated capital cost, structural sketches, and model pictures. While generating the R&D information, it will also contain the R&D attribute information corresponding to the R&D information, such as creator, creation time, modifier, and modification time.

To manage the design information, embodiments of the present application have to access to this design information. This design information is input by the design participants who create it. When the design participant inputs the information, to ensure the accuracy of the input information, the input information of each design participant needs to be screened to obtain the information corresponding to the input authority of each design participant, and the information is used as the initial design information. In other words, if the design participant inputs design information that does not match his or her input authority, it will be screened out. If the design information is not filtered out, it may cause unnecessary errors in the subsequent display. The input authority of the design participant is determined according to the functions of the design participant in the design process, and different functions correspond to different input authorities. For example, the user's input authority is only to input user demands. By filtering all the input information of the design participant, the information that meets the input authority of the design participant is used as the initial design information. For example, if the user inputs user demand information and estimated time cost information, the estimated time cost information will be filtered out, because the estimated time cost information can only be input by the corresponding input authority of the product manager. That is, the user demand information is used as the initial design information of the user in the present disclosure.

After obtaining the initial design information, an information model is constructed based on the initial design information. To differentiate from the information model thereafter, the information model constituted by the initial design information is denoted as an initial design information model. The initial design model is essentially a database storing the initial design information.

When the design participant inputs information, the information corresponds to different carrier forms. The carrier forms include text form and other forms, and the other forms include picture form and video form. For example, textual information generated by functional analysis, behavioral analysis, and structural design, picture information such as sketches drawn, and textual information such as creation date and creator's name automatically generated based on this.

When different types of carrier forms are obtained, the embodiment of the present application needs to select the target carrier form of the target design information. The target carrier form here is a text form, i.e., the embodiment of the present application needs to select the initial design information in text form as the target design information from the initial design information in different types of carrier forms. For other forms of design information, the embodiment of the present application adopts the processing method of direct storage, i.e., the other forms of design information are directly stored in the database.

After obtaining the target design information, the text processing is performed on the target design information to extract the subject information from the target design information. Specifically, the target design information is input into a predetermined text processing model for information extraction from to obtain the subject information of the target design information.

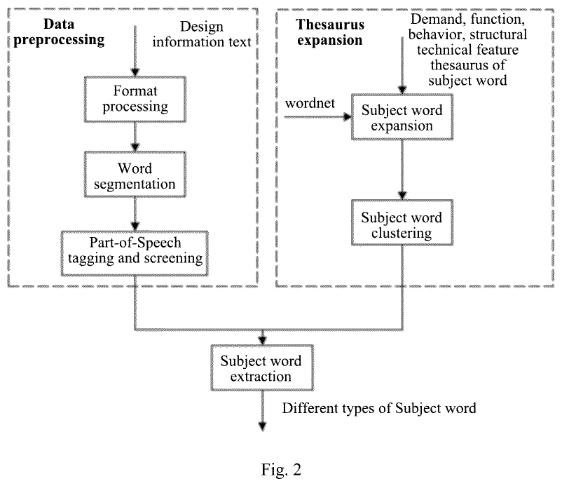

In an embodiment, the text processing model selects a commonly used subject word extraction model. The specific processing in the subject word extraction model is shown in FIG. 2, where data preprocessing and thesaurus expansion are carried out. The data preprocessing includes format processing, word separation and magnetic labeling screening. In the thesaurus expansion, the subject word thesaurus of demand, function, behavior, structure, and technical features is expanded and clustered such that the different types of subject words are extracted.

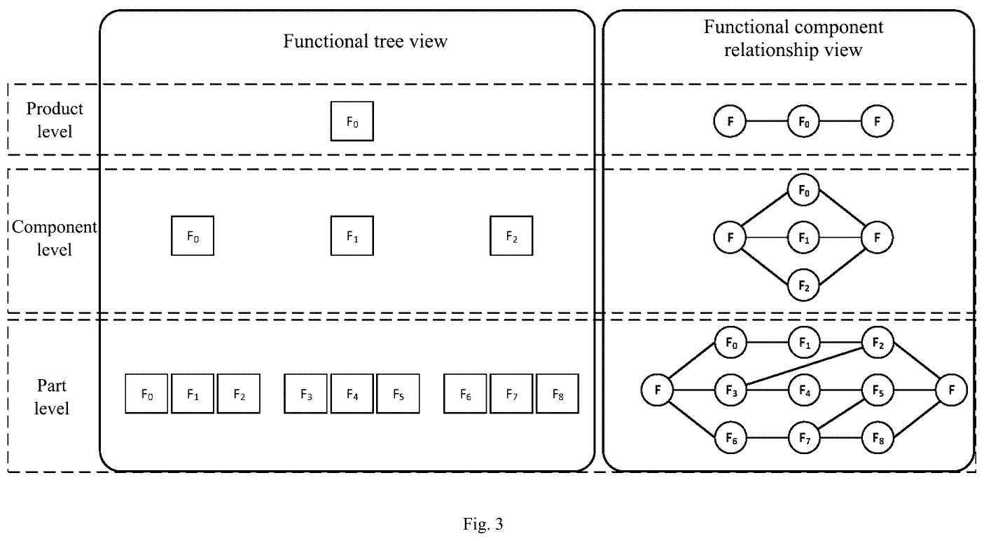

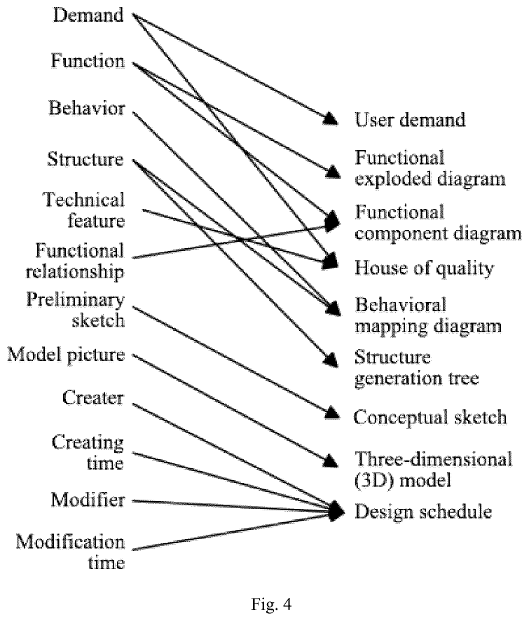

After obtaining the subject word of the target design information, a plurality of different dimensions are set to give the design participants a more comprehensive understanding of the data. Visualized views are generated under each dimension for the subject information. The dimensions include at least a vertical product dimension and a horizontal part dimension. Under the vertical product dimension, the target product is divided into different levels. For example, it is divided into a product level, a component level and a part level. Under each level, a visualized view corresponding to that level is generated. Specifically, under the vertical product dimension, a functional tree view, a functional component relationship view, a behavioral view, a product structure view, and a design progress view are generated as shown in FIG. 3. Under the horizontal part dimension, a mapping relationship is pre-set, and the subject information is transformed into the corresponding visualized view according to the mapping relationship. The details are shown in FIG. 4.

After the visualized view is generated, it needs to be displayed on the graphical user interface for viewing by multiple types of design participants. To ensure the security of the information, the display authority of the design participants need to be verified when the design participants view the information. When displaying, only the visualized view corresponding to the display authority of the design participant is displayed. In other words, each visualized view corresponds to a display authority, and the visualized view will be not displayed to the design participant whose display authority is above or below the display authority corresponding to the visualized view.

The display authority of the design participant is determined through the following steps.

A mapping relationship is constructed between the plurality of design participants and the visualized views based on a concerning content of the design participant and an actual situation of conceptual design of a target product. The display authority corresponding to the design participant is configured based on the mapping relationship.

For example, users only pay attention to functions and appearance of products, whether their personal needs can be reflected in the product, and whether the product functions can satisfy their needs. The product manager needs to convert actual demands of the users into the actual functions of the product, and focus on determining the user demands that the final product needs to satisfy. Conceptual designers are the main force of conceptual design, and therefore focus on the overall design of the product from the demands to the actual structure of the product. The structural designer is more concerned with how the final conceptual solution is further transformed into a real product. Therefore, although the structural designers are also concerned with the conceptual design process, they more consider how to carry out the subsequent detailed design from the information of conceptual design. Overall, different design participants are concerned with different views of expression, and for the same view, they have different levels of concern and different levels of operational authority.

In an embodiment, to ensure the accuracy of the data, after viewing the visualized view, each design participant may modify the visualized view if there are deficiencies in the visualized view.

After the information is modified by the design participant, the corresponding modification authority of the design participant needs to be verified. If the modification authority of the design participant allows the participant to perform the modification operation, additional information corresponding to the modification operation is generated. The modification operation includes addition, deletion, and change of the visualized view. If the participant does not have the authority to modify the visualized view, he or she is not allowed to modify the visualized view. Furthermore, if the participant has only one individual authority, he or she can only perform the operation corresponding to that authority. For example, if a participant has only the addition authority, he or she can only add information to the visualized view, but cannot delete or modify it. The process of assigning modification authorities to design participants is similar to the process of assigning display authorities, and will not be repeated here.

Supplementary information is used to modify the visualized view. After the visualized view is modified, a new visualized view is generated. The new visualized is displayed at the next time when it is viewed. The new visualized view is displayed in the same way as the previous visualized view, and is only displayed to the design participants who have the corresponding display authorities.

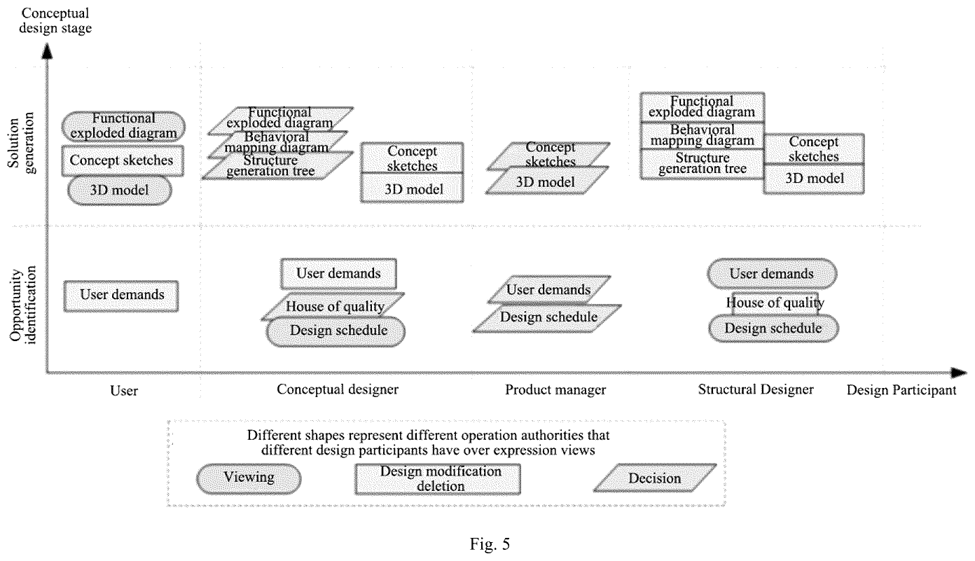

To facilitate the design participant to carry out the modification operation, an operation authority identification of the design participant for the visualized view is displayed when displaying the visualized view. Different operation authorities correspond to different operation authority identification, which are specifically shown in FIG. 5.

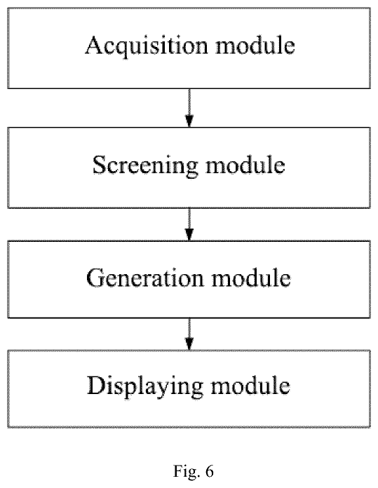

Referring to FIG. 6, a system for multi-participant based conceptual design information modeling is provided, where a terminal device provides a graphical user interface. The system includes an acquisition module, a screening module, a generation module and a displaying module.

The acquisition module is configured to acquire initial design information generated by a plurality of design participants respectively involved in different design stages during a conceptual design process of a target product, wherein the initial design information is configured to construct an initial design information model.

The screening module is configured to screen target design information in a target carrier form from the initial design information according to a carrier form corresponding to the initial design information, and extract subject information from the target design information.

The generation module is configured to generate a plurality of visualized views of the subject information under a plurality of dimension, based on a plurality of visualized forms under the plurality of dimensions.

The displaying module is configured to display the plurality of visualized views respectively to the plurality of design participants based on display authority on the graphical user interface in response to a first display operation, wherein the graphical user interface is provided by a terminal device.

The generation module is also configured to generate a supplementary information to modify the plurality of visualized views in response to an information modification operation in a case that the plurality of design participants have a modification authority, and update the plurality of visualized views according to the supplementary information to obtain a plurality of updated visualized views, wherein the supplementary information is configured to modify the initial design information model to obtain a target design information model.

The displaying module is configured to display the plurality of visualized views respectively to the plurality of design participants based on display authority on the graphical user interface in response to a second display operation, where the graphical user interface is provided by a terminal device.

The initial design information is acquired through the following steps.

Input information of each of the plurality of design participants is acquired in response to an information input operation, where the input information comprises research information and development attribute information generated during research and development process.

The information in the input information corresponding to an input authority of the plurality of design participants is used as the initial design information.

The carrier form includes textual form. The screening module is configured to screen the target design information in the textual form from the initial design information, and subject the target design information to text processing to obtain a subject matter word of the target design information.

The generation module is configured to divide the subject information into a plurality of levels based on a vertical product dimension and generate a plurality of first visualized views respectively corresponding to the plurality of levels, and generate a plurality of second visualized views corresponding to the subject information in accordance with a preset mapping relationship based on a horizontal part dimension, where the plurality of visualized views comprises the plurality of first visualized views and the plurality of second visualized views.

The displaying module is configured to display an operation authority identification of the design participant on the visualized view when displaying the visualized view.

The display authority is determined through the following steps.

A mapping relationship between the plurality of design participants and the visualized views is constructed based on a concerning content of the design participant and an actual situation of conceptual design of a target product.

The display authority corresponding to the design participant is configured based on the mapping relationship.

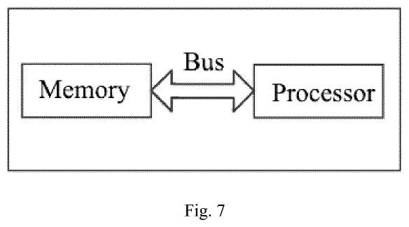

Referring to FIG. 7, an electronic device is provided in this application, which is used to implement the aforementioned method. The electronic device includes a processor, a memory, a bus and a computer program stored in the memory and runnable on the processor, where the computer program is configured to be executed by the processor to implement the aforementioned method.

Specifically, the memory and the processor may be a universal memory and processor, which are not specifically limited herein. The processor is capable of executing the above-described method for multi-participant based conceptual design information modeling when running the computer program stored on the memory.

Based on the method for multi-participant based conceptual design information modeling, this application also provides a computer-readable storage medium, which is configured to store a computer program. The computer program is configured to implement the aforementioned method when run by a processor.

Specifically, the storage medium may be a universal storage medium, such as a removable disk and a hard disk. The computer program stored in the storage medium is capable of executing the above-described method when run on the storage medium.

It should be understood that the disclosed system and method may be realized in other ways. The system embodiments described above are merely schematic. For example, the division of the units is merely a logical functional division, and may be divided in other ways when actually implemented. Multiple units or components may be combined or integrated into another system, or some features may be ignored or not implemented. Furthermore, the shown or discussed coupling or direct coupling or communication connection may be realized through communication interfaces. The indirect coupling or communication connection between systems or units may be electrical, mechanical or in other forms.

The units illustrated as separated components may or may not be physically separated. Components shown as units may or may not be physical units, which may be located in one place or distributed over a plurality of network units. Some or all of these units may be selected to fulfill the purpose of this embodiment according to the actual need.

Alternatively, the functional units in the embodiments provided in the present application may be integrated in a single processing unit, or the individual units may be physically separate, or two or more units may be integrated in a single unit.

The functionality may be stored in a non-transitory computer-readable storage medium if implemented as a software functional unit and sold or used as a separate product. Based on this, the technical solution essentially or in part a contribution to the prior art, or part of the technical solution, may be embodied in the form of a software product. The software product is stored in a storage medium and includes a number of instructions to make a computer device (i.e., a personal computer, a server, and a network device) to perform all or part of the steps of the method described in the various embodiments of the present application. The aforementioned storage media include a USB flash drive, a removable hard disk, a read-only memory (ROM), a random-access memory (RAM), a diskette, or a CD-ROM, and other media that can store program code.

It should be noted that similar symbols and letters denote similar items in the following drawings. In this case, once an item is defined in one drawing, no further definition or explanation is required in subsequent drawings. Furthermore, the terms “first”, “second”, and “third” are merely used to distinguish descriptions, and are not to be understood as indicating or implying relative importance.

Finally, it should be noted that the above-mentioned embodiments are only specific embodiments of the present application, which are used to illustrate the technical solutions of the present application, rather than limiting the scope of protection of the present application. Therefore, the scope of protection of the present application is not limited thereto. Although the present application has been described in detail with reference to the above-mentioned embodiments, it should be understood that one of ordinary skill in the art may still modify the technical solutions recorded in the foregoing embodiments, or make equivalent substitutions for some of the technical features therein. Those modifications, changes or substitutions made without departing from the spirit of the present disclosure shall fall within the scope of the present disclosure defined by the appended claims.

What is claimed is:

1. A method for multi-participant-based conceptual design information modeling, comprising:
acquiring initial design information generated by a plurality of design participants respectively involved in different design stages during a conceptual design process of a target product, wherein the initial design information is configured to construct an initial design information model;
according to a carrier form corresponding to the initial design information, screening target design information in a target carrier form from the initial design information; and extracting subject information from the target design information;
based on a plurality of visualized forms under a plurality of dimensions, generating a plurality of visualized views of the subject information under the plurality of dimensions;
in response to a first display operation, displaying, on a graphical user interface, the plurality of visualized views respectively to the plurality of design participants based on display authority, wherein the graphical user interface is provided by a terminal device;
if the plurality of design participants have a modification authority, generating supplementary information to modify the plurality of visualized views in response to an information modification operation, wherein the supplementary information is configured to modify the initial design information model to obtain a target design information model; and
updating the plurality of visualized views according to the supplementary information to obtain a plurality of updated visualized view;
wherein the carrier form comprises text form;
the step of obtaining target design information in a target carrier form from the initial design information by screening and extracting subject information from the target design information comprises:
screening the target design information in the text form from the initial design information; and
subjecting the target design information to text processing to obtain a subject word of the target design information;
the step of based on a plurality of visualized forms under a plurality of dimensions, generating a plurality of visualized views of the subject information under the plurality of dimensions comprises:
dividing the subject information into a plurality of levels based on a vertical product dimension; and generating a plurality of first visualized views respectively corresponding to the plurality of levels; and
generating a plurality of second visualized views corresponding to the subject information in accordance with a preset mapping relationship based on a horizontal part dimension, wherein the plurality of visualized views comprises the plurality of first visualized views and the plurality of second visualized views;
the initial design information is acquired through the following steps:
acquiring input information of each of the plurality of design participants in response to an information input operation, wherein the input information comprises research and development information, and research and development attribute information generated during a research and development process; and
selecting information in the input information corresponding to an input authority of the plurality of design participants as the initial design information; and
the method further comprises:
in response to a second display operation,
displaying, on the graphical user interface, the plurality of updated visualized views to the plurality of design participants based on the display authority.

2. The method of claim 1, further comprising:
when displaying the plurality of visualized views, displaying an operation authority identification of the plurality of design participants on each of the plurality of visualized views.

3. The method of claim 1, wherein the display authority is determined through the following steps:
constructing a mapping relationship between the plurality of design participants and the plurality of visualized views based on a concerning design content of the plurality of design participants and an actual situation of the conceptual design of the target product; and
correspondingly configuring the display authority for the plurality of design participants based on the mapping relationship.

4. A system for multi-participant-based conceptual design information modeling, comprising:
an acquisition module;
a screening module;
a generation module; and
a displaying module;
wherein the acquisition module is configured to acquire initial design information generated by a plurality of design participants respectively involved in different design stages during a conceptual design process of a target product, wherein the initial design information is configured to construct an initial design information model;
the screening module is configured to screen target design information in a target carrier form from the initial design information according to a carrier form corresponding to the initial design information, and extract subject information from the target design information;
the generation module is configured to generate a plurality of visualized views of the subject information under a plurality of dimension, based on a plurality of visualized forms under the plurality of dimensions; and
the displaying module is configured to display the plurality of visualized views respectively to the plurality of design participants based on display authority on the graphical user interface in response to a first display operation, wherein the graphical user interface is provided by a terminal device;
the generation module is also configured to generate a supplementary information to modify the plurality of visualized views in response to an information modification operation in a case that the plurality of design participants have a modification authority, and update the plurality of visualized views according to the supplementary information to obtain a plurality of updated visualized views, wherein the supplementary information is configured to modify the initial design information model to obtain a target design information model;
the carrier form comprises text form;
the screening module is configured to screen the target design information in the text form from the initial design information, and subject the target design information to text processing to obtain a subject word of the target design information;
the generation module is configured to divide the subject information into a plurality of levels based on a vertical product dimension and generate a plurality of first visualized views respectively corresponding to the plurality of levels, and generate a plurality of second visualized views corresponding to the subject information in accordance with a preset mapping relationship based on a horizontal part dimension, wherein the plurality of visualized views comprises the plurality of first visualized views and the plurality of second visualized views; and
the acquisition module is configured to perform the following steps to obtain the initial design information:
acquiring input information of each of the plurality of design participants in response to an information input operation, wherein the input information comprises research and development information, and research and development attribute information generated during a research and development process; and
selecting information in the input information corresponding to an input authority of the plurality of design participants as the initial design information.

5. An electronic device, comprising:
a processor;
a memory; and
a bus;
wherein the memory is configured to store a machine-readable instruction executable by the processor; the processor is configured to be in communication connection with the memory via the bus during operation of the electronic device; and
the machine-readable instruction is configured to be executed by the processor to implement the method of claim 1.

6. A non-transitory computer-readable storage medium, wherein the computer-readable storage medium is configured to store a computer program; and the computer program is configured to be executed by a processor to implement the method of claim 1.
